(19) United States
(12) Patent Application Publication
(10) Pub. No.: US 2024/0340747 A1
(43) Pub. Date: Oct. 10, 2024

(54) INFORMATION TRANSMISSION METHOD AND APPARATUS, COMMUNICATION DEVICE, AND STORAGE MEDIUM

(71) Applicant: Beijing Xiaomi Mobile Software Co., Ltd., Beijing (CN)

(72) Inventor: Xiaolong LI, Beijing (CN)

(21) Appl. No.: 18/294,994

(22) PCT Filed: Aug. 5, 2021
(86) PCT No.: PCT/CN2021/110895

§ 371 Date: Feb. 2, 2024

(51) Int. Cl. H04W 36/32

(52) U.S. Cl. CPC H04W 36/322

(57) ABSTRACT

An information transmission method includes: a non-terrestrial network (NTN) device sends reselection time information to a user equipment (UE), where the reselection time information is at least used for determining cell reselection moment; the reselection time information includes at least one of the following: first auxiliary information indicating the cell reselection moment; second auxiliary information indicating a correspondence relation between each zone in an NTN serving cell and the cell reselection moment; or third auxiliary information indicating cell reselection moment of a reference position in the NTN serving cell.

### BACKGROUND

Non-terrestrial networks (NTNs) have been introduced into the 5th generation (5G) cellular mobile communication system. In an NTN system, a feeder link switch and a service link switch are generated with the movement of a high-altitude platform station such as a satellite. Here, a wireless link between a high-altitude platform station such as a satellite and a service ground station such as a satellite gateway, a core network and other control network nodes is referred to as a feeder link, and a wireless link between a high-altitude platform station such as a satellite and a terminal device is referred to as a service link.

### SUMMARY

The examples of the disclosure provide a method and apparatus for transmitting information, a communication device, and a storage medium.

According to a first aspect of examples of the disclosure, a method for transmitting information is provided. The method is executed by a non-terrestrial network (NTN) device, and includes:
sending reselection time information to user equipment (UE), where the reselection time information is at least configured to determine a cell reselection moment, and the reselection time information includes at least one of the following:
first auxiliary information indicating the cell reselection moment;
second auxiliary information indicating a correspondence relation between each zone in an NTN serving cell and the cell reselection moment; or
third auxiliary information indicating a cell reselection moment of a reference position in the NTN serving cell.

According to a second aspect of examples of the disclosure, a method for transmitting information is provided. The method is executed by user equipment (UE), and includes:
receiving reselection time information, where the reselection time information is at least configured to determine a cell reselection moment, and the reselection time information includes at least one of the following:
first auxiliary information indicating the cell reselection moment;
second auxiliary information including a correspondence relation between each zone in an NTN serving cell and the cell reselection moment; or
third auxiliary information indicating a cell reselection moment of a reference position in the NTN serving cell.

According to a third aspect of examples of the disclosure, a communication device is provided, and includes a processor, a memory, and an executable program stored in the memory and executable by the processor. The processor executes steps of the method for according to the transmitting information according to the first aspect when running the executable program.

According to a fourth aspect of examples of the disclosure, a communication device is provided, and includes a processor, a memory, and an executable program stored in the memory and executable by the processor. The processor executes steps of the method for according to the transmitting information according to the second aspect when running the executable program.

It should be understood that both the foregoing general description and the following detailed description are illustrative and explanatory merely and do not restrict examples of the disclosure.

### BRIEF DESCRIPTION OF THE DRAWINGS

The drawings here are incorporated in the description as a constituent part of the description, illustrate examples conforming to the disclosure, and serve to explain principles of the disclosure along with the description.

FIG. 1 is a schematic structural diagram of a radio communication system according to an example;

FIG. 2a is a flowchart of a method for transmitting information according to an example;

FIG. 2b is a flowchart of a method for transmitting information according to an example;

FIG. 2c is a flowchart of a method for transmitting information according to an example;

FIG. 3a is a flowchart of a method for transmitting information according to an example;

FIG. 3b is a flowchart of a method for transmitting information according to an example;

FIG. 3c is a flowchart of a method for transmitting information according to an example;

FIG. 4 is a flowchart of a method for transmitting information according to an example;

FIG. 5 is a flowchart of a method for transmitting information according to an example;

FIG. 6 is a flowchart of a method for transmitting information according to an example;

FIG. 7a is a block diagram of an apparatus for transmitting information according to an example;

FIG. 7b is a block diagram of an apparatus for transmitting information according to an example;

FIG. 7c is a block diagram of an apparatus for transmitting information according to an example;

FIG. 8a is a block diagram of an apparatus for transmitting information according to an example;

FIG. 8b is a block diagram of an apparatus for transmitting information according to an example;

FIG. 8c is a block diagram of an apparatus for transmitting information according to an example; and

FIG. 9 is a block diagram of an apparatus for transmitting information according to an example.

### DETAILED DESCRIPTION

Description will be made in detail to examples here, instances of which are illustrated in the accompanying drawings. When the following description relates to the accompanying drawings, the same numbers in different accompanying drawings refer to the same or similar elements unless otherwise indicated. The embodiments described in the following examples do not represent all embodiments consistent with the examples of the disclosure. Rather, they are merely instances of apparatus and methods consistent with some aspects of the examples of the disclosure as described in detail in the appended claims.

The term used in the examples of the disclosure is for the purpose of describing particular examples merely and is not intended to limit the examples of the disclosure. As used in the examples and the appended claims of the disclosure, singular forms “a/an”, “said” and “the” are intended to include plural forms as well, unless otherwise indicated in the context clearly. It should be understood that the term “and/or” as used here refers to and encompasses any or all possible combinations of one or more of associated listed items.

It should be understood that although the terms of first, second, third, etc. may be employed in the examples of the disclosure to describe various information, such information should not be limited to these terms. These terms are merely used to distinguish the same type of information from each other. For example, first information may also be referred to as second information, and similarly, second information may also be referred to as first information, without departing from the scope of the examples of the disclosure. The word “if” as used here may be construed to mean “at the time of” or “when” or “in response to determining”, depending on the context.

A satellite establishes feeder links with different control network nodes during movement, and user equipment (UE) also establishes service links with different satellites. UE in a cell needs to perform cell reselection in case of a feeder link switch and/or a service link switch. As for this, the disclosure provides a technical solution, which relates to, but is not limited to, the technical field of radio communication, and in particular relates to a method and apparatus for transmitting information, a communication device, and a storage medium. In this way, the cell reselection moment is determined by means of the reselection time information, and the cell reselection moment is not determined based on a signal measurement result of a serving cell, such that the situation that NTN serving cell coverage cannot cover the UE due to movement of the NTN serving cell is reduced, and a success rate of cell reselection is improved.

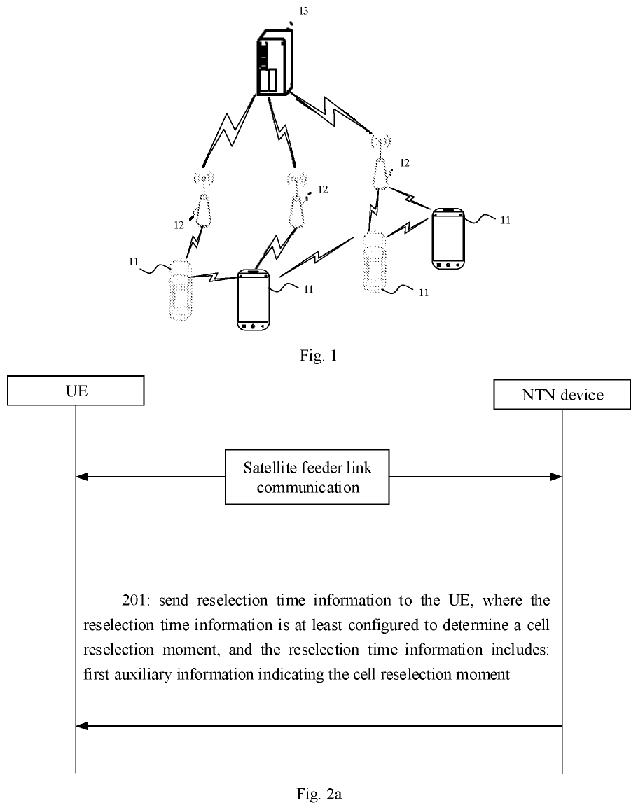

With reference to FIG. 1, a schematic structural diagram of a radio communication system provided in an example of the disclosure is shown. As shown in FIG. 1, the radio communication system is a communication system based on a cellular mobile communication technology. The radio communication system may include: several terminals 11 and several base stations 12.

The terminal 11 may be a device that provides speech and/or data connectivity for a user. The terminal 11 may communicate with one or more core networks by means of a radio access network (RAN), and the terminal 11 may be an Internet of Things terminal, for example, a sensor device, a mobile telephone (or referred to as a “cellular” telephone), and a computer having an Internet of Things terminal, for example, may be a stationary, portable, pocket-sized, hand-held, computer-built, or vehicle-mounted device, for example, a station (STA), a subscriber unit, a subscriber station, a mobile station, a mobile, a remote station, an access point, a remote terminal, an access terminal, a user terminal, a user agent, a user device, or user equipment (UE). Alternatively, the terminal 11 may be a device of an unmanned aerial vehicle. Alternatively, the terminal 11 may be an in-vehicle device, for example, a trip computer with a radio communication function, or a radio communication device to which a trip computer is externally connected. Alternatively, the terminal 11 may be a roadside device, for example, a street lamp, a signal lamp, another roadside device, etc. with the radio communication function.

The base station 12 may be a network side device in the radio communication system. The radio communication system may be the 4th generation mobile communication (4G) system, also referred to as a long term evolution (LTE) system; and alternatively, the radio communication system may also be a 5G system, also referred to as a new radio (NR) system or a 5G NR system. Alternatively, the radio communication system may also be a next generation system consecutive to the 5G system. An access network in the 5G system may be referred to as a new generation-radio access network (NG-RAN). Alternatively, the radio communication system may be a machine-type communication (MTC) system.

The base station 12 may be an evolved Node B (eNB) used in a 4G system. Alternatively, the base station 12 may also be a next-generation Node B (gNB) using a central distributed architecture in a 5G system. When the base station 12 uses the central distributed architecture, it typically includes a central unit (CU) and at least two distributed units (DU). The central unit is provided with protocol stacks of a packet data convergence protocol (PDCP) layer, a radio link control (RLC) layer and a media access control (MAC) layer; and each distributed unit is provided with a protocol stack of a physical (PHY) layer. Examples of the disclosure are not limited to the specific implementation modes of the base station 12.

A radio connection may be established between the base stations 12 and the terminals 11 by means of radio air interfaces. In different embodiments, the radio air interface is a radio air interface based on a 4th generation mobile communication network technology (4G) standard; alternatively, the radio air interface is a radio air interface based on a 5th generation mobile communication network technology (5G) standard, for example, the radio air interface is a new radio; and alternatively, the radio air interface may also be a radio air interface based on a 5G-based next generation mobile communication network technology standard.

In some examples, an end to end (E2E) connection may also be established between the terminals 11, for example, vehicle to vehicle (V2V) communication, vehicle to infrastructure (V2I) communication, vehicle to pedestrian (V2P) communication, etc. of vehicle to everything (V2X) communication.

In some examples, the above-mentioned radio communication system may further include a network management device 13.

The several base stations 12 are each connected to the network management device 13. The network management device 13 may be a core network device in the radio communication system, for example, the network management device 13 may be a mobility management entity (MME) in an evolved packet core (EPC). Alternatively, the network management device 13 may be another core network device, for example, a serving gateway (SGW), a public data network gateway (PGW), a policy and charging rules function (PCRF), or a home subscriber server (HSS), etc. The examples of the disclosure do not limit an implementation form of the network management device 13.

Executive bodies involved in the examples of the disclosure include, but are not limited to, a satellite achieving covering of a non-terrestrial cellular mobile communication network, user equipment such as a mobile phone terminal that uses a cellular mobile communication network technology for radio communication, and a base station.

An application scene of the examples of the disclosure is that a base station (gNB) is suddenly unavailable in case of a feeder link switch of a non-terrestrial network (NTN), such that if UE starts measurement on a neighboring cell according to an S criterion, it may cause that the UE has not started measurement on the neighboring cell yet, but a serving cell is suddenly unavailable, resulting too late cell reselection by the UE.

The NTN supports an earth fixed cell scene and an earth moving cell scene. The earth fixed cell scene refers to that a cell generated by satellite signal covering is fixed relative to a position on the earth for a certain time. This can be achieved by generating a steerable beam fixed on the ground by a satellite. The earth moving cell scene refers to a cell generated by satellite signal covering moves on the ground as a satellite moves. How the UE determines a cell reselection time under the earth moving cell scene is an urgent problem to be solved.

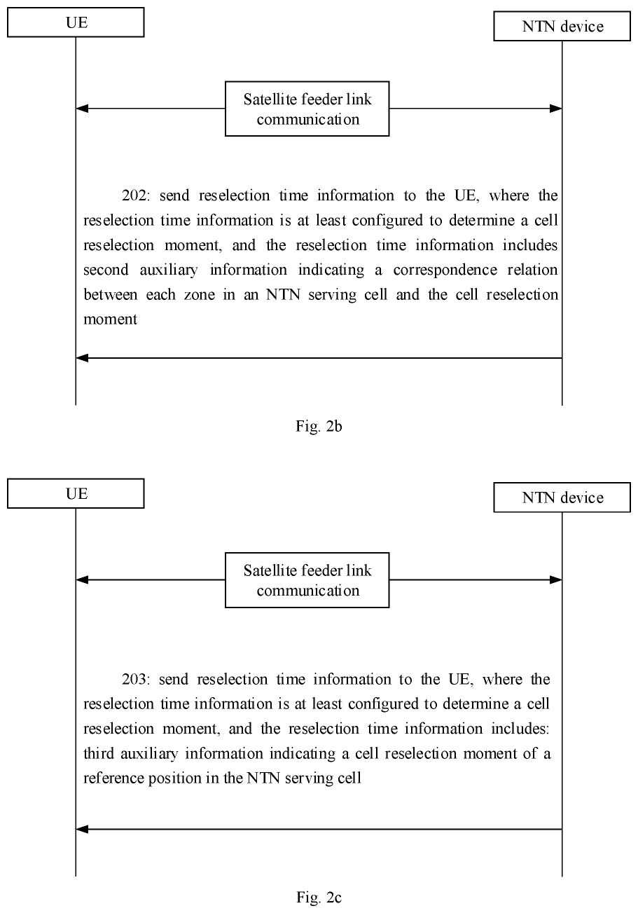

As shown in FIG. 2a, the example provides a method for transmitting information. The method for transmitting information is applicable to an NTN device for radio communication, and includes:
step 201: send reselection time information to UE. The reselection time information is at least configured to determine a cell reselection moment. The reselection time information includes:
first auxiliary information indicating the cell reselection moment.

The UE may be a mobile phone terminal that uses a cellular mobile communication network technology for radio communication. The NTN device includes, but is not limited to, a satellite, a base station, a core network, etc.

The method in the example of the disclosure may be applied to, but not limited to, an earth moving cell scene, that is to say, an NTN serving cell works in a moving scene.

Since a radio signal covering the NTN serving cell of the UE is provided by a satellite, the NTN serving cell moves as the satellite moves. When the cell reselection is performed based on the S criterion, the radio signal fails to cover the NTN serving cell moving rapidly, such that the UE has not started measurement on a neighbor cell yet, and the NTN serving cell is suddenly unavailable, resulting in cell reselection failure.

The reselection time information may be provided for the UE to determine the cell reselection moment not based on a measurement result of signal quality measurement on the serving cell. The cell reselection moment that may be determined by the UE according to the reselection time information may be determined based on movement information of the NTN serving cell and/or position information of the UE, etc. Thus, the situation that a radio signal cannot cover the UE due to the movement of the NTN serving cell in a cell reselection process of the UE is reduced, and the cell reselection success rate is improved.

In an example, the reselection time information may include first auxiliary information indicating the cell reselection moment.

The first auxiliary information may be used by the NTN device, such as a core network, a base station, and/or a satellite to determine the cell reselection moment based on the movement information of the NTN serving cell and/or a position information of the UE.

Illustratively, the first auxiliary information may be indication information of the cell reselection moment determined by a network side device. After the UE receives the first auxiliary information, the UE may directly obtain a reselection moment without calculation.

The NTN device may determine the cell reselection moment based on at least the following conditions:
a position of the UE in a cell; and
a motion state of the UE satisfying a stationary condition. Illustratively, the UE does not move with the NTN serving cell. It can be understood that the motion state of the UE satisfying a stationary condition may include, but not limited to: a motion speed of the UE less than a preset speed or the UE being a fixed terminal; a time when the UE enters an inactive state;
a motion state of a satellite, such as an orbital altitude and a motion speed of the satellite; and
the duration that the NTN serving cell signal may provide service for the UE greater than a duration threshold, etc.

The cell reselection moment indicated by the first auxiliary information may be a universal time coordinated (UTC) moment or an ephemeris reference moment.

In an example, the first auxiliary information is determined by the NTN device according to at least the following information:
position information of the UE;
an obtainment time of the position information; and
time information of the UE entering a disconnected state, where the disconnected state includes an idle state or an inactive state.

When the UE is in the disconnected state, the UE establishes no connection to the base station, and thus the position information of the UE in the disconnected state cannot be directly sent. Here, the position information of the UE may be position information of the UE when the UE is connected to the base station for communication or during communication connection establishment. The obtainment time of the position information may be time that the UE obtains the position information. Based on the position information of the UE and the time at which the position information is obtained, the NTN device may determine the position of the UE at the time.

In an example, the position information of the UE includes one of the following:
position information reported when the UE is in a random access process; or
position information reported when the UE is in a radio resource control (RRC) connected state.

The UE may carry the position information in uplink signaling in the random access process.

The UE may also use RRC signaling to report the position information determined when the UE is in an RRC connected state.

The position information of the UE may be position information determined by taking the NTN serving cell as a reference system. That is, using a fixed position in the NTN serving cell as a reference point, the position information of the UE is relative position information relative to the fixed position. For example, the fixed position may be a center of the serving cell, and the position information of the UE may be a distance and an angle from the center. The position information of the UE may also be position information of GPS coordinates. The NTN device may obtain the position information of the UE and the time at which the UE obtains the position information. If the UE enters a disconnected state such as an RRC idle state, the NTN device may record a time of entering the disconnected state. The NTN device determines a time at which service can be provided for the UE according to a difference between the time at which the UE obtains the position information and the time at which the UE enters the disconnected state, the position information of the UE and the motion information of the satellite, and further determines the cell reselection moment of the UE. The NTN device may send the first auxiliary information indicating the cell reselection moment to the UE.

In an example, the sending reselection time information to user equipment (UE) includes:
send radio resource control (RRC) release signaling carrying the first auxiliary information to the UE.

The RRC release signaling may be last downlink signaling received by the UE before entering the RRC disconnected state. The NTN device may send the RRC release signaling carrying the first auxiliary information to the UE. The UE may perform cell reselection based on the first auxiliary information when in the RRC disconnected state.

In an example, the sending reselection time information to user equipment (UE) includes:
send radio resource control (RRC) resume signaling carrying the first auxiliary information to the UE in an inactive state.

As shown in FIG. 2b, the example provides a method for transmitting information. The method for transmitting information is applicable to an NTN device for radio communication, and includes:
step 202: send reselection time information to UE. The reselection time information is at least configured to determine a cell reselection moment. The reselection time information includes:
second auxiliary information indicating a correspondence relation between each zone in an NTN serving cell and the cell reselection moment.

Step 202 may be implemented alone or in combination with step 201.

Here, the NTN device may send the correspondence relation between each zone in the NTN serving cell and the cell reselection moment to the UE. The UE may determine the zone where the UE is located based on the position of the UE, and further determine the cell reselection moment according to the correspondence relation.

One serving cell may be divided into N zones, and one zone corresponds to one cell reselection moment. Through the second auxiliary information, a network side may inform the UE of the cell reselection moments of the N zones at one time, such that the UE may conveniently determine the cell reselection moment according to the zone where the UE is currently located.

Zones connected to each other may be divided in the NTN cell. Zone information of zones may be determined based on NTN cell information, or may be determined based on a geographical position. For example, zone information of zones is determined based on NTN cell information may include that the zone information of zones is determined based on a relative position between a boundary of the zone and a reference point such as a central point of the NTN cell. If the zone information is determined based on geographical position information, the boundary of the zone, etc. may be determined based on a world coordinate system. The NTN device and the UE may divide the zone based on same rules. The rule may be agreed upon, or may be sent to the UE by the NTN device by means of downlink information. For example, a parameter for dividing the zones may be carried in the second auxiliary information and sent to the UE.

The cell reselection moment indicated by the second auxiliary information may be a UTC moment or an ephemeris reference moment.

In an example, the second auxiliary information includes:
a zone identifier of each zone, and a cell reselection moment corresponding to each zone identifier.

Here, each zone in the NTN serving cell may separately have a zone identifier uniquely identifying and corresponding to the cell. The correspondence relation between each zone and the cell reselection moment may be a correspondence relation between the zone identifier of each zone and the cell reselection moment. The UE may determine the zone identifier of the zone where the UE is located based on the position of the UE, and further determine the cell reselection moment according to the correspondence relation.

Here, the zone identifier may be determined by the NTN device based on the position of the zone. For example, some rules may be set, and the positions of different position zones may determine a zone identifier based on the rules. In this way, the zone identifier may be determined based on the position of the zone, and then the cell reselection moment can be determined. The UE may determine the zone identifiers of different zones based on the same rules.

In an example, the second auxiliary information further includes zone information. The zone information is configured to determine a geographical zone corresponding to the zone identifier.

In an example, the zone information may include at least one of the following:
length information of a length of the zone in a first direction, length information of
a length of the zone in a second direction, a modulo parameter of the length in the first direction, a modulo parameter of the length in the second direction, and position information of a zone reference point.

In another example, the zone information may include at least one of the following:
length information of a length of the zone in a first direction, length information of a length of the zone in a second direction, a modulo parameter of the length in the first direction, and a modulo parameter of the length in the second direction.

Here, the zone may be a rectangular zone, the length in the first direction may be a length of the rectangle, and the length in the second direction may be a width of the rectangle.

The UE may determine the zone identifier of the zone where the UE is located based on a known zone reference point, the length information of the length of the zone in the first direction, the length information of the length of the zone in the second direction, the modulo parameter of the length in the first direction, and the modulo parameter of the length in the second direction.

In an example, position information of the zone reference point may be carried in the second auxiliary information and sent to the UE. The zone reference point may also be a geographical position specified or agreed upon in a communication protocol. The UE may determine the position information of the zone reference point based on the second auxiliary information, and may also determine the position information of the zone reference point based on a communication protocol, etc.

Illustratively, the UE may determine the zone where the UE is located based on coordinates of the UE, coordinates of the zone reference point, the length of the zone in the first direction, and the length of the zone in the second direction. The UE may determine the zone identifier based on the modulo parameter of the length in the first direction and the modulo parameter of the length in the second direction.

Illustratively, the UE may determine the zone identifier Zone_id of the zone where the UE is located according to expressions (1), (2) and (3).

$${x}_{1} = FLOOR ( x / L ) Mod {N}_{x} \qquad ( 1 )$$

$${y}_{1} = FLOOR ( y / W ) Mod {N}_{y} \qquad ( 2 )$$

$$Zone\_id = {y}_{1} * {N}_{x} + {x}_{1} * {N}_{y} \qquad ( 3 )$$

Here, x and y are distances between the UE and the zone reference point in the first direction and the second direction respectively. L and W are lengths of the zone in the first direction and the second direction respectively, Nx and Ny are a modulo parameter of the length in the first direction and a modulo parameter of the length in the second direction respectively, and FLOOR ( ) represents rounding down.

Here, other parameters may also be used as the parameters Nx and/or Ny in expression (3), such that a unique Zone_id can be generated based on x1 and y1.

The position of the UE and the position of the zone reference point may be latitude and longitude coordinates. The first direction and the second direction may be a longitude line direction and a latitude line direction respectively.

As shown in FIG. 2c, the example provides a method for transmitting information. The method for transmitting information is applicable to an NTN device for radio communication, and includes:

step 203: send reselection time information to UE. The reselection time information is at least configured to determine a cell reselection moment. The reselection time information includes:
third auxiliary information indicating a cell reselection moment of a reference position in the NTN serving cell.

Step 203 may be implemented alone or in combination with step 201 and/or step 202.

Here, the NTN device may send the cell reselection moment of the reference position in the NTN serving cell to the UE. The UE may determine the cell reselection moment based on a distance between the position of the UE and the reference position.

Illustratively, the reference position is the central position of the cell. The closer the UE is to the central position of the cell, the longer the time for which the NTN serving cell can provide service is, and the later the cell reselection moment of the UE is. The farther the UE is from the central position of the cell, the shorter the time for which the NTN serving cell can provide service is, and the earlier the cell reselection moment of the UE is.

The cell reselection moment indicated by the third auxiliary information may be a UTC moment or an ephemeris reference moment.

In an example, after determining the cell reselection moment, the UE may perform measurement on a neighbor cell from the cell reselection moment, and select a neighbor cell satisfying a reselection condition for access.

In this way, the cell reselection moment is determined by means of the reselection time information, and the cell reselection moment is not determined based on a signal measurement result of a serving cell, such that the situation that NTN serving cell coverage cannot cover the UE due to movement of the NTN serving cell is reduced, and a success rate of cell reselection is improved.

In an example, the third auxiliary information includes:
position information of the reference position;
cell reselection moment information of the reference position; and
coverage information of the NTN serving cell.

The NTN device may send the coverage information of the NTN serving cell, the position information of the reference position, and the cell reselection moment corresponding to the reference position to the UE. The UE determines the cell reselection moment of the UE based on a distance between the UE and the reference position.

In an example, the UE determines a duration for which the NTN serving cell can provide service according to the position information of the UE, the position information of the reference position, the coverage of the NTN serving cell, movement information of a satellite, etc., and further determines the cell reselection moment of the UE based on first auxiliary information of the cell corresponding to the reference position. The movement information of a satellite may be determined based on ephemeris information of the satellite.

In an example, the reference position includes a central position of the NTN serving cell.

Here, the central position of the NTN serving cell may be determined as the reference position, that is, the central position of a zone covered by the NTN serving cell is the reference position. Calculating the coverage of the NTN serving cell based on the central position of the NTN serving cell, etc., may be more convenient, so as to improve efficiency in determining the cell reselection moment of the UE.

In an example, the step of sending reselection time information to user equipment (UE) includes at least one of the following:
send a system message carrying the second auxiliary information to the UE;
send a system message carrying the third auxiliary information to the UE;
send RRC signaling carrying the second auxiliary information to the UE; or
send RRC signaling carrying the third auxiliary information to the UE.

Here, the system message may include, but is not limited to, a master information block (MIB) message, a system information block (SIB) message, etc.

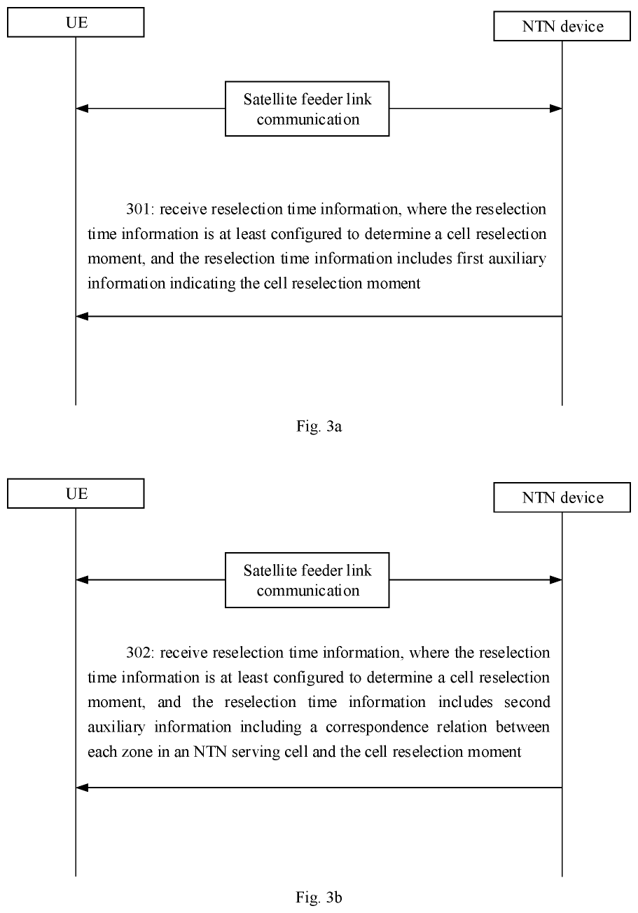

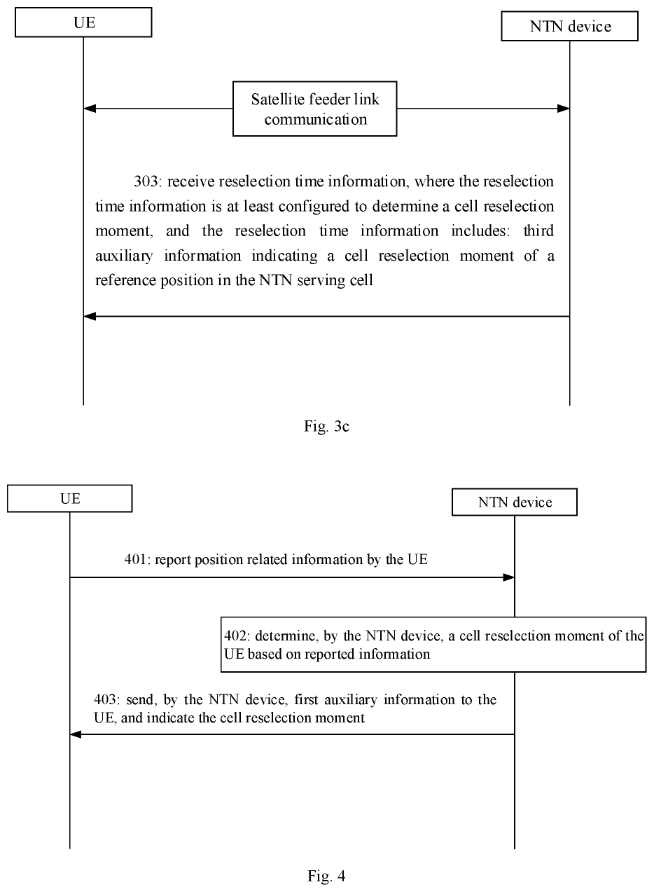

As shown in FIG. 3a, the example provides a method for transmitting information. The method for transmitting information is applicable to UE for radio communication, and includes:
step 301: receive reselection time information. The reselection time information is at least configured to determine a cell reselection moment. The reselection time information includes first auxiliary information indicating the cell reselection moment.

The UE may be a mobile phone terminal that uses a cellular mobile communication network technology for radio communication. The NTN device includes, but is not limited to, a satellite, a base station, a core network, etc.

The method in the example of the disclosure may be applied to, but not limited to, an earth moving cell scene, that is to say, an NTN serving cell works in a moving scene.

Since a radio signal covering the NTN serving cell of the UE is provided by a satellite, the NTN serving cell moves as the satellite moves. When the cell reselection is performed based on the S criterion, the radio signal fails to cover the NTN serving cell moving rapidly, such that the UE has not started measurement on a neighbor cell yet, and the NTN serving cell is suddenly unavailable, resulting in cell reselection failure.

The reselection time information may be provided for the UE to determine the cell reselection moment not based on a measurement result of signal quality measurement on the serving cell. The cell reselection moment that may be determined by the UE according to the reselection time information may be determined based on movement information of the NTN serving cell and/or position information of the UE, etc. Thus, the situation that a radio signal cannot cover the UE due to the movement of the NTN serving cell in a cell reselection process of the UE is reduced, and the cell reselection success rate is improved.

In an example, the reselection time information may include first auxiliary information indicating the cell reselection moment.

The first auxiliary information may be used by the NTN device, such as a core network, a base station, and/or a satellite to determine the cell reselection moment based on the movement information of the NTN serving cell and/or a position information of the UE.

Illustratively, the first auxiliary information may be indication information of the cell reselection moment determined by a network side device. After the UE receives the first auxiliary information, the UE may directly obtain a reselection moment without calculation.

The NTN device may determine the cell reselection moment based on at least the following conditions:
a position of the UE in a cell; and
a motion state of the UE satisfying a stationary condition. Illustratively, the UE does not move with the NTN serving cell. It can be understood that the motion state of the UE satisfying a stationary condition may include, but not limited to: a motion speed of the UE less than a preset speed or the UE being a fixed terminal;
a time when the UE enters an inactive state;
a motion state of a satellite, such as an orbital altitude and a motion speed of the satellite; and
the duration that the NTN serving cell signal may provide service for the UE greater than a duration threshold, etc.

The cell reselection moment indicated by the first auxiliary information may be a universal time coordinated (UTC) moment or an ephemeris reference moment.

In an example, the method further includes:
determine the cell reselection moment of the UE according to the first auxiliary information.

The UE may directly determine the cell reselection moment according to the indication of the first auxiliary information.

In an example, the method further includes:
report position information of the UE and an obtainment time of the position information.

When the UE is in the disconnected state, the UE establishes no connection to the base station, and thus the position information of the UE in the disconnected state cannot be directly sent. Here, the position information of the UE may be position information of the UE when the UE is connected to the base station for communication or during communication connection establishment. The obtainment time of the position information may be time that the UE obtains the position information. Based on the position information of the UE and the obtainment time of the position information, the NTN device may determine the position of the UE at the time.

In an example, the position information of the UE includes one of the following:
position information reported when the UE is in a random access process; or
position information reported when the UE is in an RRC connected state.

The UE may carry the position information in uplink signaling in the random access process.

The UE may also use RRC signaling to report the position information determined when the UE is in an RRC connected state.

The position information of the UE may be position information determined by taking the NTN serving cell as a reference system. That is, using a fixed position in the NTN serving cell as a reference point, the position information of the UE is relative position information relative to the fixed position. For example, the fixed position may be a center of the serving cell, and the position information of the UE may be a distance and an angle from the center. The position information of the UE may also be position information of GPS coordinates.

The NTN device may obtain the position information of the UE and the time at which the UE obtains the position information.

If the UE enters a disconnected state such as an RRC idle state, the NTN device may record a time of entering the disconnected state. The NTN device determines a moment at which service can be provided for the UE according to a difference between the time at which the UE obtains the position information and the time at which the UE enters the disconnected state, the position information of the UE and the motion information of the satellite, and further determines the cell reselection moment of the UE. The NTN device may send the first auxiliary information indicating the cell reselection time to the UE.

In an example, the step of receiving reselection time information includes:
receive radio resource control (RRC) release signaling carrying the first auxiliary information.

The RRC release signaling may be last downlink signaling received by the UE before entering the RRC disconnected state. The NTN device may send the RRC release signaling carrying the first auxiliary information to the UE. The UE may perform cell reselection based on the first auxiliary information when in the RRC disconnected state.

In an example, the step of receiving reselection time information includes:
receive radio resource control (RRC) resume signaling carrying the first auxiliary information.

As shown in FIG. 3b, the example provides a method for transmitting information. The method for transmitting information is applicable to UE for radio communication, and includes:

step 302: receive reselection time information. The reselection time information is at least configured to determine a cell reselection moment. The reselection time information includes second auxiliary information indicating a correspondence relation between each zone in an NTN serving cell and the cell reselection moment.

Step 302 may be implemented alone or in combination with step 301.

Here, the NTN device may send the correspondence relation between each zone in the NTN serving cell and the cell reselection moment to the UE. The UE may determine the zone where the UE is located based on the position of the UE, and further determine the cell reselection moment according to the correspondence relation.

One serving cell may be divided into N zones. One zone corresponds to one cell reselection moment. Through the second auxiliary information, a network side may inform the UE of the cell reselection moments of the N zones at one time, such that the UE may conveniently determine the cell reselection moment according to the zone where the UE is currently located.

Zones connected to each other may be divided in the NTN cell. Zone information of zones, for example, identifier information of the zones, may be determined based on NTN cell information, or may be determined based on a geographical position. For example, zone information of zones is determined based on NTN cell information may include that the zone information of zones is determined based on a relative position between a boundary of the zone and a reference point such as a central point of the NTN cell. If the zone information is determined based on geographical position information, the boundary of the zone, etc. may be determined based on a world coordinate system. The NTN device and the UE may divide the zone based on same rules. The rule may be agreed upon, or may be sent to the UE by the NTN device by means of downlink information. For example, a parameter for dividing the zones may be carried in the second auxiliary information and sent to the UE.

The cell reselection moment indicated by the second auxiliary information may be a UTC moment or an ephemeris reference moment.

In an example, the second auxiliary information includes:
a zone identifier of each zone, and a cell reselection moment corresponding to each zone identifier.

Here, each zone in the NTN serving cell may separately have a zone identifier uniquely identifying and corresponding to the cell. The correspondence relation between each zone and the cell reselection moment may be a correspondence relation between the zone identifier of each zone and the cell reselection moment. The UE may determine the zone identifier of the zone where the UE is located based on the position of the UE, and further determine the cell reselection moment according to the correspondence relation.

Here, the zone identifier may be determined by the NTN device based on the position of the zone. For example, some rules may be set, and the positions of different position zones may determine a zone identifier based on the rules. In this way, the zone identifier may be determined based on the position of the zone, and then the cell reselection moment can be determined. The UE may determine the zone identifiers of different zones based on the same rules.

In an example, the second auxiliary information further includes zone information. The zone information is configured to determine a geographical zone corresponding to the zone identifier.

In an example, the zone information may include at least one of the following:
length information of a length of the zone in a first direction, length information of a length of the zone in a second direction, a modulo parameter of the length in the first direction, a modulo parameter of the length in the second direction, and position information of a zone reference point.

In another example, the zone information may include at least one of the following:
length information of a length of the zone in a first direction, length information of a length of the zone in a second direction, a modulo parameter of the length in the first direction, and a modulo parameter of the length in the second direction.

Here, the zone may be a rectangular zone, the length in the first direction may be a length of the rectangle, and the length in the second direction may be a width of the rectangle.

The UE may determine the zone identifier of the zone where the UE is located based on a known zone reference point, the length information of the length of the zone in the first direction, the length information of the length of the zone in the second direction, the modulo parameter of the length in the first direction, and the modulo parameter of the length in the second direction.

In an example, the zone reference point is predetermined.

In an example, position information of the zone reference point may be carried in the second auxiliary information and sent to the UE. The zone reference point may also be a geographical position specified or agreed upon in a communication protocol. The UE may determine the position information of the zone reference point based on the second auxiliary information, and may also determine the position information of the zone reference point based on a communication protocol, etc.

In an example, the method further includes:
determine the cell reselection moment of the UE according to the second auxiliary information.

Illustratively, the UE may determine the zone where the UE is located based on coordinates of the UE, coordinates of the zone reference point, the length of the zone in the first direction, and the length of the zone in the second direction. The UE may determine the zone identifier based on the modulo parameter of the length in the first direction and the modulo parameter of the length in the second direction.

In an example, the step of determining the cell reselection moment of the UE according to the second auxiliary information includes:
determine a corresponding first distance and a corresponding second distance between the UE and the zone reference point in the first direction and the second direction respectively;
round a quotient obtained by dividing the first distance by the length of the zone in the first direction, obtain a first integer quotient, perform modulo operation on the first integer quotient by using the modulo parameter of the length in the first direction, and obtain a first modulo value;
round a quotient obtained by dividing the second distance by the length of the zone in the second direction, obtain a second integer quotient, perform modulo operation on the second integer quotient by using the modulo parameter of the length in the second direction, and obtain a second modulo value;
determine a zone identifier of a zone where the UE is located based on the first modulo value and the second modulo value; and
determine the cell reselection moment corresponding to the zone identifier of the zone where the UE is located.

Illustratively, the UE may determine the zone identifier Zone_id of the zone where the UE is located according to expressions (1), (2) and (3). Here, x and y are distances between the UE and the zone reference point in the first direction and the second direction respectively. L and W are lengths of the zone in the first direction and the second direction respectively, Nx and Ny are a modulo parameter of the length in the first direction and a modulo parameter of the length in the second direction respectively, and FLOOR ( ) represents rounding down.

Here, other parameters may also be used as the parameters Nx and/or Ny in expression (3), such that a unique Zone_id can be generated based on x1 and y1.

The position of the UE and the position of the zone reference point may be latitude and longitude coordinates. The first direction and the second direction may be a longitude line direction and a latitude line direction respectively.

As shown in FIG. 3c, the example provides a method for transmitting information. The method for transmitting information is applicable to UE for radio communication, and includes:

Step 303: receive reselection time information. The reselection time information is at least configured to determine a cell reselection moment. The reselection time information includes third auxiliary information indicating a cell reselection moment of a reference position in the NTN serving cell.

Step 303 may be implemented alone or in combination with step 301 and/or 302.

Here, the NTN device may send the cell reselection moment of the reference position in the NTN serving cell to the UE. The UE may determine the cell reselection moment based on a distance between the position of the UE and the reference position.

Illustratively, the reference position is the central position of the cell. The closer the UE is to the central position of the cell, the longer the time for which the NTN serving cell can provide service is, and the later the cell reselection moment of the UE is. The farther the UE is from the central position of the cell, the shorter the time for which the NTN serving cell can provide service is, and the earlier the cell reselection moment of the UE is.

The cell reselection moment indicated by the third auxiliary information may be a UTC moment or an ephemeris reference moment.

In an example, after determining the cell reselection moment, the UE may perform measurement on a neighbor cell from the cell reselection moment, and select a neighbor cell satisfying a reselection condition for access.

In this way, the cell reselection moment is determined by means of the reselection time information, and the cell reselection moment is not determined based on a signal measurement result of a serving cell, such that the situation that NTN serving cell coverage cannot cover the UE due to movement of the NTN serving cell is reduced, and a success rate of cell reselection is improved.

In an example, the third auxiliary information indicates:
position information of the reference position;
cell reselection moment information of the reference position; and
coverage of the NTN serving cell.

The NTN device may send the coverage information of the NTN serving cell, the position information of the reference position, and the cell reselection moment corresponding to the reference position to the UE. The UE determines the cell reselection moment of the UE based on a distance between the UE and the reference position.

In an example, the method further includes:
determine the cell reselection moment of the UE according to the third auxiliary information, ephemeris information associated with the NTN serving cell, and a position of the UE.

In an example, the UE determines a duration for which the NTN serving cell can provide service according to the position information of the UE, the position information of the reference position, the coverage of the NTN serving cell, movement information of a satellite, etc., and further determines the cell reselection moment of the UE based on first auxiliary information of the cell corresponding to the reference position. The movement information of a satellite may be determined based on ephemeris information of the satellite.

In an example, the reference position includes a central position of the NTN serving cell.

Here, the central position of the NTN serving cell may be determined as the reference position, that is, the central position of a zone covered by the NTN serving cell is a reference. Calculating the coverage of the NTN serving cell based on the central position of the NTN serving cell, etc., may be more convenient, so as to improve efficiency in determining the cell reselection moment of the UE.

In an example, the step of receiving reselection time information includes at least one of the following:
receive a system message carrying the second auxiliary information;
receive a system message carrying the third auxiliary information;
receive RRC signaling carrying the second auxiliary information; or
receive RRC signaling carrying the third auxiliary information.

Here, the system message may include, but is not limited to, an MIB message, a SIB message, etc.

As shown in FIG. 4, the example provides a method for transmitting information. The method includes:

Step 401: report position related information by UE: report, by the UE, position information of the UE and an obtainment time of obtaining the position information by the UE, etc. to an NTN device.

Step 402: determine, by the NTN device, a cell reselection moment of the UE based on the reported information: determine, by the NTN device, a change condition of the position of the UE relative to a signal coverage of an NTN serving cell based on the position information of the UE, the obtainment time of obtaining the position information by the UE, and time information of the UE entering a disconnected state, determine a moment at which the NTN serving cell can provide service for the UE, and further determine the cell reselection moment of the UE.

Step 403: send, by the NTN device, first auxiliary information to the UE, and indicate the cell reselection moment.

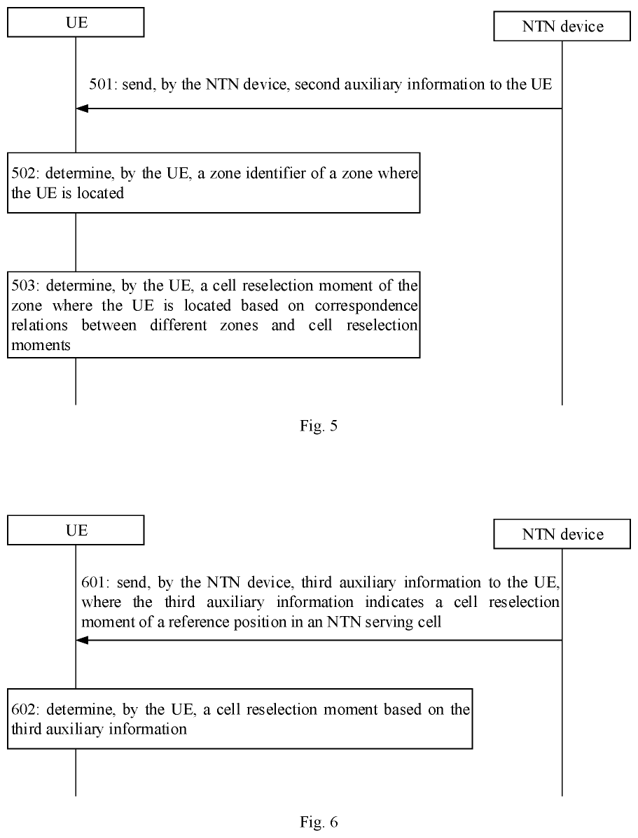

As shown in FIG. 5, the example provides a method for transmitting information. The method includes:

Step 501: send, by the NTN device, second auxiliary information to the UE. The second auxiliary information indicates a correspondence relation between each zone in an NTN serving cell and a cell reselection moment, and a parameter for the UE to determine a zone identifier of a zone where the UE is located. The parameter includes length information of a length of the zone in a first direction, length information of a length of the zone in a second direction, a modulo parameter of the length in the first direction, and a modulo parameter of the length in the second direction.

Step 502: determine, by the UE, a zone identifier of a zone where the UE is located. The UE determines the zone identifier of the zone where the UE is located according to expressions (1), (2) and (3) based on position information of the UE, position information of a zone reference point and the second auxiliary information. The position information of the zone reference point may be carried in the second auxiliary information, or may be predetermined.

Step 503: determine, by the UE, a cell reselection moment of the zone where the UE is located, that is, the cell reselection moment of the UE, based on the correspondence relations between different zones and cell reselection moments.

As shown in FIG. 6, the example provides a method for transmitting information. The method includes:

Step 601: send, by an NTN device, third auxiliary information to UE. The third auxiliary information indicates a cell reselection moment of a reference position in an NTN serving cell. The third auxiliary information may also indicate coverage of the NTN serving cell. The coverage of NTN serving cell may be predetermined. The reference position may be a central position of the serving cell.

Step 602: determine, by the UE, a cell reselection moment based on the third auxiliary information. The UE determines a duration for which the NTN serving cell can provide service according to the position information of the UE, the position information of the reference position, the coverage of the NTN serving cell, movement information of a satellite, etc., and further determines the cell reselection moment of the UE based on cell first auxiliary information at the reference position. The movement information of a satellite may be determined based on ephemeris information of the satellite.

A specific instance is provided below in conjunction with any one of the examples described above:

The methods shown in FIGS. 4, 5 and 6 may be implemented separately or in combination. 1. An NTN determines time information assisting UE in cell reselection in one of the following ways, including:
based on time information of position information of the UE;
based on time information corresponding to a zone; or
based on time information of a reference point.

2. Based on time information of position information of the UE. The NTN may determine the time information according to:
the position information of the UE;
a time of obtaining the position information of the UE; and
a time when the UE enters an RRC idle state.

3. The NTN may obtain the position information of the UE in a random access
process of the UE or may obtain the position information of the UE after the UE enters the RRC connected state.

4. The NTN sends the above-mentioned time information to the UE through an RRC message, such as an RRC release message.

5. Based on time information corresponding to a zone. The NTN divides cell coverage into different zones, and different zones correspond to different time information.

6. The NTN sends parameters for determining different zones to the UE.

7. The parameters determining different zones include:
a zone length;
a zone width;
a length modulo parameter;
a width modulo parameter; and
reference point coordinates.

8. The NTN may send different time information corresponding to different zones and a parameter for determining a zone to the UE through a system message and/or an RRC message.

9. The UE determines the zone where the UE is located according to the parameter for determining a zone, and then determines the time information.

10. A method for determining the zone by the UE is:
the UE calculates a longitude line distance and a latitude line distance between the position of the UE and the reference point separately; and
a zone ID is determined by rounding down the longitude line distance and the latitude line distance with the length and the width respectively, then performing modulo operation on rounded results with the length modulo parameter and the width modulo parameter respectively, and obtaining the zone identifier.

11. The reference point may be a parameter configured by the network in 7, or may also be fixed coordinates agreed upon.

12. Based on time information of a reference point

The network determines the time information corresponding to the reference point, and the reference point may be a cell center.

13. The network sends position information of the reference point, the time information corresponding to the reference point, and coverage information of a cell (for example, a coverage radius of the cell) to the UE.

14. The UE determines the time information for cell reselection according to the position information and the information in 13.

15. The UE performs measurement on a neighbor cell based on the cell reselection time determined by using the time information.

16. A time in the time information may be:
a UTC time; or
an ephemeris reference time.

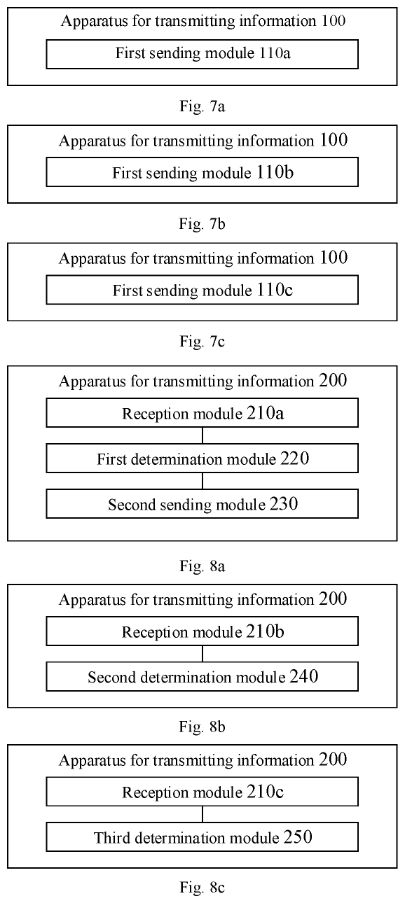

The examples of the disclosure further provide an apparatus for transmitting information, performed by an NTN device. As shown in FIG. 7a, the apparatus 100 for transmitting information includes:
a first sending module 110a configured to send reselection time information to user equipment (UE). The reselection time information is at least configured to determine a cell reselection moment. The reselection time information includes first auxiliary information indicating the cell reselection moment.

The UE may be a mobile phone terminal that uses a cellular mobile communication network technology for radio communication. The NTN device includes, but is not limited to, a satellite, a base station, a core network, etc.

The method in the example of the disclosure may be applied to, but not limited to, an earth moving cell scene, that is to say, an NTN serving cell works in a moving scene.

Since a radio signal covering the NTN serving cell of the UE is provided by a satellite, the NTN serving cell moves as the satellite moves. When the cell reselection is performed based on the S criterion, the radio signal fails to cover the NTN serving cell moving rapidly, such that the UE has not started measurement on a neighbor cell yet, and the NTN serving cell is suddenly unavailable, resulting in cell reselection failure.

The reselection time information may be provided for the UE to determine the cell reselection moment not based on a measurement result of signal quality measurement on the serving cell. The cell reselection moment that may be determined by the UE according to the reselection time information may be determined based on movement information of the NTN serving cell and/or position information of the UE, etc. Thus, the situation that a radio signal cannot cover the UE due to the movement of the NTN serving cell in a cell reselection process of the UE is reduced, and the cell reselection success rate is improved.

In an example, the reselection time information may include first auxiliary information indicating the cell reselection moment.

The first auxiliary information may be used by the NTN device, such as a core network, a base station, and/or a satellite to determine the cell reselection moment based on the movement information of the NTN serving cell and/or a position information of the UE.

Illustratively, the first auxiliary information may be indication information of the cell reselection moment determined by a network side device. After the UE receives the first auxiliary information, the UE may directly obtain a reselection moment without calculation.

The NTN device may determine the cell reselection moment based on at least the following conditions:
a position of the UE in a cell; and
a motion state of the UE satisfying a stationary condition. Illustratively, the UE does not move with the NTN serving cell. It can be understood that the motion state of the UE satisfying a stationary condition may include, but not limited to: a motion speed of the UE less than a preset speed or the UE being a fixed terminal;
a time when the UE enters an inactive state;
a motion state of a satellite, such as an orbital altitude and a motion speed of the satellite; and
the duration that the NTN serving cell signal may provide service for the UE greater than a duration threshold, etc.

The cell reselection moment indicated by the first auxiliary information may be a universal time coordinated (UTC) moment or an ephemeris reference moment.

In an example, the first auxiliary information is determined by the NTN device according to at least the following information:
position information of the UE;
an obtainment time of the position information; and
time information of the UE entering a disconnected state, where the disconnected state includes an idle state or an inactive state.

When the UE is in the disconnected state, the UE establishes no connection to the base station, and thus the position information of the UE in the disconnected state cannot be directly sent. Here, the position information of the UE may be position information of the UE when the UE is connected to the base station for communication or during communication connection establishment. The obtainment time of the position information may be time that the UE obtains the position information. Based on the position information of the UE and the time at which the position information is obtained, the NTN device may determine the position of the UE at the time.

In an example, the position information of the UE includes one of the following:
position information reported when the UE is in a random access process; or
position information reported when the UE is in an RRC connected state.

The UE may carry the position information in uplink signaling in the random access process.

The UE may also use RRC signaling to report the position information determined when the UE is in an RRC connected state.

The position information of the UE may be position information determined by taking the NTN serving cell as a reference system. That is, using a fixed position in the NTN serving cell as a reference point, the position information of the UE is relative position information relative to the fixed position. For example, the fixed position may be a center of the serving cell, and the position information of the UE may be a distance and an angle from the center. The position information of the UE may also be position information of GPS coordinates. The NTN device may obtain the position information of the UE and the time at which the UE obtains the position information. If the UE enters a disconnected state such as an RRC idle state, the NTN device may record a time of entering the disconnected state. The NTN device determines a time at which service can be provided for the UE according to a difference between the time at which the UE obtains the position information and the time at which the UE enters the disconnected state, the position information of the UE and the motion information of the satellite, and further determines the cell reselection moment of the UE. The NTN device may send the first auxiliary information indicating the cell reselection moment to the UE.

In an example, the first sending module 110a is configured to:
send radio resource control (RRC) release signaling carrying the first auxiliary information to the UE.

The RRC release signaling may be last downlink signaling received by the UE before entering the RRC disconnected state. The NTN device may send the RRC release signaling carrying the first auxiliary information to the UE. The UE may perform cell reselection based on the first auxiliary information when in the RRC disconnected state.

In an example, the first sending module 110a is configured to:
send radio resource control (RRC) resume signaling carrying the first auxiliary information to the UE in an inactive state.

The examples of the disclosure further provide an apparatus for transmitting information, performed by an NTN device. As shown in FIG. 7b, the apparatus 100 for transmitting information includes:
a first sending module 110b configured to send reselection time information to user equipment (UE). The reselection time information is at least configured to determine a cell reselection moment. The reselection time information includes:
second auxiliary information indicating a correspondence relation between each zone in an NTN serving cell and the cell reselection moment.

The first sending module 110a shown in FIG. 7b may be implemented alone or in combination with the example shown in FIG. 7a.

Here, the NTN device may send the correspondence relation between each zone in the NTN serving cell and the cell reselection moment to the UE. The UE may determine the zone where the UE is located based on the position of the UE, and further determine the cell reselection moment according to the correspondence relation.

One serving cell may be divided into N zones, and one zone corresponds to one cell reselection moment. Through the second auxiliary information, a network side may inform the UE of the cell reselection moments of the N zones at one time, such that the UE may conveniently determine the cell reselection moment according to the zone where the UE is currently located.

Zones connected to each other may be divided in the NTN cell. Zone information of zones may be determined based on NTN cell information, or may be determined based on a geographical position. For example, zone information of zones is determined based on NTN cell information may include that the zone information of zones is determined based on a relative position between a boundary of the zone and a reference point such as a central point of the NTN cell. If the zone information is determined based on geographical position information, the boundary of the zone, etc. may be determined based on a world coordinate system. The NTN device and the UE may divide the zone based on same rules. The rule may be agreed upon, or may be sent to the UE by the NTN device by means of downlink information. For example, a parameter for dividing the zones may be carried in the second auxiliary information and sent to the UE.

The cell reselection moment indicated by the second auxiliary information may be a UTC moment or an ephemeris reference moment.

In an example, the second auxiliary information includes:
a zone identifier of each zone, and a cell reselection moment corresponding to each zone identifier.

Here, each zone in the NTN serving cell may separately have a zone identifier uniquely identifying and corresponding to the cell. The correspondence relation between each zone and the cell reselection moment may be a correspondence relation between the zone identifier of each zone and the cell reselection moment. The UE may determine the zone identifier of the zone where the UE is located based on the position of the UE, and further determine the cell reselection moment according to the correspondence relation.

Here, the zone identifier may be determined by the NTN device based on the position of the zone. For example, some rules may be set, and the positions of different position zones may determine a zone identifier based on the rules. In this way, the zone identifier may be determined based on the position of the zone, and then the cell reselection moment can be determined. The UE may determine the zone identifiers of different zones based on the same rules.

In an example, the second auxiliary information further includes zone information. The zone information is configured to determine a geographical zone corresponding to the zone identifier.

In an example, the second auxiliary information further includes length information of a length of the zone in a first direction, length information of a length of the zone in a second direction, a modulo parameter of the length in the first direction, a modulo parameter of the length in the second direction, and position information of a zone reference point;
or,
the second auxiliary information further includes length information of a length of the zone in a first direction, length information of a length of the zone in a second direction, a modulo parameter of the length in the first direction, and a modulo parameter of the length in the second direction.

Here, the zone may be a rectangular zone, the length in the first direction may be a length of the rectangle, and the length in the second direction may be a width of the rectangle.

The UE may determine the zone identifier of the zone where the UE is located based on a known zone reference point, the length information of the length of the zone in the first direction, the length information of the length of the zone in the second direction, the modulo parameter of the length in the first direction, and the modulo parameter of the length in the second direction.

In an example, position information of the zone reference point may be carried in the second auxiliary information and sent to the UE. The zone reference point may also be a geographical position specified or agreed upon in a communication protocol. The UE may determine the position information of the zone reference point based on the second auxiliary information, and may also determine the position information of the zone reference point based on a communication protocol, etc.

Illustratively, the UE may determine the zone where the UE is located based on coordinates of the UE, coordinates of the zone reference point, the length of the zone in the first direction, and the length of the zone in the second direction. The UE may determine the zone identifier based on the modulo parameter of the length in the first direction and the modulo parameter of the length in the second direction.

Illustratively, the UE may determine the zone identifier Zone_id of the zone where the UE is located according to expressions (1), (2) and (3).

Here, x and y are distances between the UE and the zone reference point in the first direction and the second direction respectively. L and W are lengths of the zone in the first direction and the second direction respectively, Nx and Ny are a modulo parameter of the length in the first direction and a modulo parameter of the length in the second direction respectively, and FLOOR ( ) represents rounding down.

Here, other parameters may also be used as the parameters Nx and/or Ny in expression (3), such that a unique Zone_id can be generated based on x1 and y1.

The position of the UE and the position of the zone reference point may be latitude and longitude coordinates. The first direction and the second direction may be a longitude line direction and a latitude line direction respectively.

The examples of the disclosure further provide an apparatus for transmitting information, performed by an NTN device. As shown in FIG. 7c, the apparatus 100 for transmitting information includes:
a first sending module 110c configured to send reselection time information to user equipment (UE). The reselection time information is at least configured to determine a cell reselection moment. The reselection time information includes:
third auxiliary information indicating a cell reselection moment of a reference position in the NTN serving cell.

The example shown in FIG. 7c may be implemented alone or in combination with the examples shown in FIG. 7a and/or FIG. 7b.

Here, the NTN device may send the cell reselection moment of the reference position in the NTN serving cell to the UE. The UE may determine the cell reselection moment based on a distance between the position of the UE and the reference position.

Illustratively, the reference position is the central position of the cell. The closer the UE is to the central position of the cell, the longer the time for which the NTN serving cell can provide service is, and the later the cell reselection moment of the UE is. The farther the UE is from the central position of the cell, the shorter the time for which the NTN serving cell can provide service is, and the earlier the cell reselection moment of the UE is.

The cell reselection moment indicated by the third auxiliary information may be a UTC moment or an ephemeris reference moment.

In an example, after determining the cell reselection moment, the UE may perform measurement on a neighbor cell from the cell reselection moment, and select a neighbor cell satisfying a reselection condition for access.

In this way, the cell reselection moment is determined by means of the reselection time information, and the cell reselection moment is not determined based on a signal measurement result of a serving cell, such that the situation that NTN serving cell coverage cannot cover the UE due to movement of the NTN serving cell is reduced, and a success rate of cell reselection is improved.

In an example, the third auxiliary information includes:
position information of the reference position;
cell reselection moment information of the reference position; and
coverage information of the NTN serving cell.

The NTN device may send the coverage information of the NTN serving cell, the position information of the reference position, and the cell reselection moment corresponding to the reference position to the UE. The UE determines the cell reselection moment of the UE based on a distance between the UE and the reference position.

In an example, the UE determines a duration for which the NTN serving cell can provide service according to the position information of the UE, the position information of the reference position, the coverage of the NTN serving cell, movement information of a satellite, etc., and further determines the cell reselection moment of the UE based on first auxiliary information of the cell corresponding to the reference position. The movement information of a satellite may be determined based on ephemeris information of the satellite.

In an example, the reference position includes a central position of the NTN serving cell.

Here, the central position of the NTN serving cell may be determined as the reference position, that is, the central position of a zone covered by the NTN serving cell is the reference position. Calculating the coverage of the NTN serving cell based on the central position of the NTN serving cell, etc., may be more convenient, so as to improve efficiency in determining the cell reselection moment of the UE.

In an example, the first sending module 110a is configured to perform at least one of the following:
sending a system message carrying the second auxiliary information to the UE;
sending a system message carrying the third auxiliary information to the UE;
sending RRC signaling carrying the second auxiliary information to the UE; or
sending RRC signaling carrying the third auxiliary information to the UE.

Here, the system message may include, but is not limited to, an MIB message, a SIB message, etc.

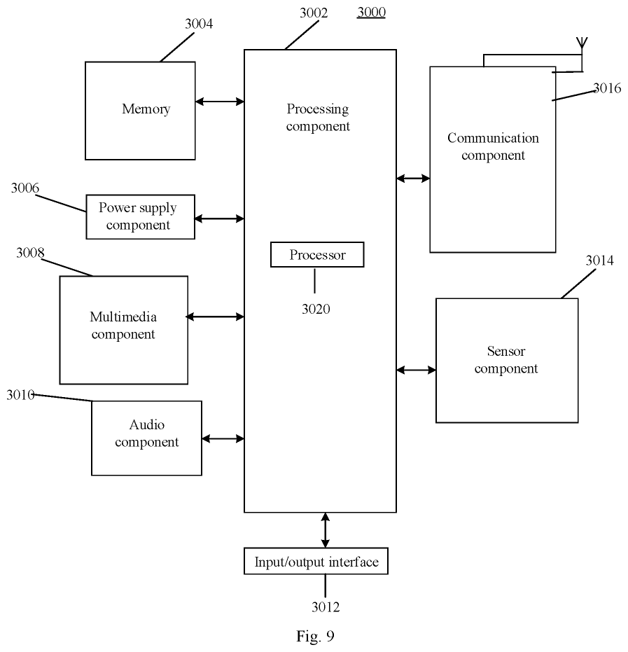

The examples of the disclosure further provide an apparatus for transmitting information, performed by UE. As shown in FIG. 8a, the apparatus 200 for transmitting information includes:
a reception module 210a configured to receive reselection time information. The reselection time information is at least configured to determine a cell reselection moment. The reselection time information includes at least one of the following:
first auxiliary information indicating the cell reselection moment.

The UE may be a mobile phone terminal that uses a cellular mobile communication network technology for radio communication. The NTN device includes, but is not limited to, a satellite, a base station, a core network, etc.

The method in the example of the disclosure may be applied to, but not limited to, an earth moving cell scene, that is to say, an NTN serving cell works in a moving scene.

Since a radio signal covering the NTN serving cell of the UE is provided by a satellite, the NTN serving cell moves as the satellite moves. When the cell reselection is performed based on the S criterion, the radio signal fails to cover the NTN serving cell moving rapidly, such that the UE has not started measurement on a neighbor cell yet, and the NTN serving cell is suddenly unavailable, resulting in cell reselection failure.

The reselection time information may be provided for the UE to determine the cell reselection moment not based on a measurement result of signal quality measurement on the serving cell. The cell reselection moment that may be determined by the UE according to the reselection time information may be determined based on movement information of the NTN serving cell and/or position information of the UE, etc. Thus, the situation that a radio signal cannot cover the UE due to the movement of the NTN serving cell in a cell reselection process of the UE is reduced, and the cell reselection success rate is improved.

In an example, the reselection time information may include first auxiliary information indicating the cell reselection moment.

The first auxiliary information may be used by the NTN device, such as a core network, a base station, and/or a satellite to determine the cell reselection moment based on the movement information of the NTN serving cell and/or a position information of the UE.

Illustratively, the first auxiliary information may be indication information of the cell reselection moment determined by a network side device. After the UE receives the first auxiliary information, the UE may directly obtain a reselection moment without calculation.

The NTN device may determine the cell reselection moment based on at least the following conditions:
a position of the UE in a cell; and
a motion state of the UE satisfying a stationary condition. Illustratively, the UE does not move with the NTN serving cell. It can be understood that the motion state of the UE satisfying a stationary condition may include, but not limited to: a motion speed of the UE less than a preset speed or the UE being a fixed terminal;
a time when the UE enters an inactive state;
a motion state of a satellite, such as an orbital altitude and a motion speed of the satellite; and
the duration that the NTN serving cell signal may provide service for the UE greater than a duration threshold, etc.

The cell reselection moment indicated by the first auxiliary information may be a universal time coordinated (UTC) moment or an ephemeris reference moment.

In an example, the apparatus 200 further includes:
a first determination module 220 configured to determine the cell reselection moment of the UE according to the first auxiliary information.

The UE may directly determine the cell reselection moment according to the indication of the first auxiliary information.

In an example, the apparatus 200 further includes:
a second sending module 230 configured to report position information of the UE and an obtainment time of the position information.

When the UE is in the disconnected state, the UE establishes no connection to the base station, and thus the position information of the UE in the disconnected state cannot be directly sent. Here, the position information of the UE may be position information of the UE when the UE is connected to the base station for communication or during communication connection establishment. The obtainment time of the position information may be time that the UE obtains the position information. Based on the position information of the UE and the obtainment time of the position information, the NTN device may determine the position of the UE at the time.

In an example, the position information of the UE includes one of the following:
position information reported when the UE is in a random access process; or
position information reported when the UE is in an RRC connected state.

The UE may carry the position information in uplink signaling in the random access process.

The UE may also use RRC signaling to report the position information determined when the UE is in an RRC connected state.

The position information of the UE may be position information determined by taking the NTN serving cell as a reference system. That is, using a fixed position in the NTN serving cell as a reference point, the position information of the UE is relative position information relative to the fixed position. For example, the fixed position may be a center of the serving cell, and the position information of the UE may be a distance and an angle from the center. The position information of the UE may also be position information of GPS coordinates.

The NTN device may obtain the position information of the UE and the time at which the UE obtains the position information.

If the UE enters a disconnected state such as an RRC idle state, the NTN device may record a time of entering the disconnected state. The NTN device determines a moment at which service can be provided for the UE according to a difference between the time at which the UE obtains the position information and the time at which the UE enters the disconnected state, the position information of the UE and the motion information of the satellite, and further determines the cell reselection moment of the UE. The NTN device may send the first auxiliary information indicating the cell reselection time to the UE.

In an example, the reception module 210a is configured to receive radio resource control (RRC) release signaling carrying the first auxiliary information.

The RRC release signaling may be last downlink signaling received by the UE before entering the RRC disconnected state. The NTN device may send the RRC release signaling carrying the first auxiliary information to the UE. The UE may perform cell reselection based on the first auxiliary information when in the RRC disconnected state.

In an example, the reception module 210a is configured to receive radio resource control (RRC) resume signaling carrying the first auxiliary information.

The examples of the disclosure further provide an apparatus for transmitting information, performed by UE. As shown in FIG. 8b, the apparatus 200 for transmitting information includes:
a reception module 210b configured to receive reselection time information. The reselection time information is at least configured to determine a cell reselection moment. The reselection time information includes:
second auxiliary information indicating a correspondence relation between each zone in an NTN serving cell and the cell reselection moment.

The example shown in FIG. 8b may be implemented alone or in combination with the example shown in FIG. 8a.

Here, the NTN device may send the correspondence relation between each zone in the NTN serving cell and the cell reselection moment to the UE. The UE may determine the zone where the UE is located based on the position of the UE, and further determine the cell reselection moment according to the correspondence relation.

One serving cell may be divided into N zones. One zone corresponds to one cell reselection moment. Through the second auxiliary information, a network side may inform the UE of the cell reselection moments of the N zones at one time, such that the UE may conveniently determine the cell reselection moment according to the zone where the UE is currently located.

Zones connected to each other may be divided in the NTN cell. Zone information of zones, for example, identifier information of the zones, may be determined based on NTN cell information, or may be determined based on a geographical position. For example, zone information of zones is determined based on NTN cell information may include that the zone information of zones is determined based on a relative position between a boundary of the zone and a reference point such as a central point of the NTN cell. If the zone information is determined based on geographical position information, the boundary of the zone, etc. may be determined based on a world coordinate system. The NTN device and the UE may divide the zone based on same rules. The rule may be agreed upon, or may be sent to the UE by the NTN device by means of downlink information. For example, a parameter for dividing the zones may be carried in the second auxiliary information and sent to the UE.

The cell reselection moment indicated by the second auxiliary information may be a UTC moment or an ephemeris reference moment.

In an example, the second auxiliary information includes:
a zone identifier of each zone, and a cell reselection moment corresponding to each zone identifier.

Here, each zone in the NTN serving cell may separately have a zone identifier uniquely identifying and corresponding to the cell. The correspondence relation between each zone and the cell reselection moment may be a correspondence relation between the zone identifier of each zone and the cell reselection moment. The UE may determine the zone identifier of the zone where the UE is located based on the position of the UE, and further determine the cell reselection moment according to the correspondence relation.

Here, the zone identifier may be determined by the NTN device based on the position of the zone. For example, some rules may be set, and the positions of different position zones may determine a zone identifier based on the rules. In this way, the zone identifier may be determined based on the position of the zone, and then the cell reselection moment can be determined. The UE may determine the zone identifiers of different zones based on the same rules.

In an example, the second auxiliary information further includes length information of a length of the zone in a first direction, length information of a length of the zone in a second direction, a modulo parameter of the length in the first direction, a modulo parameter of the length in the second direction, and position information of a zone reference point;
or,
the second auxiliary information further includes length information of a length of the zone in a first direction, length information of a length of the zone in a second direction, a modulo parameter of the length in the first direction, and a modulo parameter of the length in the second direction.

Here, the zone may be a rectangular zone, the length in the first direction may be a length of the rectangle, and the length in the second direction may be a width of the rectangle.

The UE may determine the zone identifier of the zone where the UE is located based on a known zone reference point, the length information of the length of the zone in the first direction, the length information of the length of the zone in the second direction, the modulo parameter of the length in the first direction, and the modulo parameter of the length in the second direction.

In an example, the zone reference point is predetermined.

In an example, position information of the zone reference point may be carried in the second auxiliary information and sent to the UE. The zone reference point may also be a geographical position specified or agreed upon in a communication protocol. The UE may determine the position information of the zone reference point based on the second auxiliary information, and may also determine the position information of the zone reference point based on a communication protocol, etc.

In an example, the apparatus 200 further includes:
a second determination module 240 configured to determine the cell reselection moment of the UE according to the second auxiliary information.

Illustratively, the UE may determine the zone where the UE is located based on coordinates of the UE, coordinates of the zone reference point, the length of the zone in the first direction, and the length of the zone in the second direction. The UE may determine the zone identifier based on the modulo parameter of the length in the first direction and the modulo parameter of the length in the second direction.

In an example, the second determination module 240 is configured to:
determine a corresponding first distance and a corresponding second distance between the UE and the zone reference point in the first direction and the second direction respectively;
round a quotient obtained by dividing the first distance by the length of the zone in the first direction, obtain a first integer quotient, perform modulo operation on the first integer quotient by using the modulo parameter of the length in the first direction, and obtain a first modulo value;
round a quotient obtained by dividing the second distance by the length of the zone in the second direction, obtain a second integer quotient, perform modulo operation on the second integer quotient by using the modulo parameter of the length in the second direction, and obtain a second modulo value;
determine a zone identifier of a zone where the UE is located based on the first modulo value and the second modulo value; and
determine the cell reselection moment corresponding to the zone identifier of the zone where the UE is located.

Illustratively, the UE may determine the zone identifier Zone_id of the zone where the UE is located according to expressions (1), (2) and (3). Here, x and y are distances between the UE and the zone reference point in the first direction and the second direction respectively. L and W are lengths of the zone in the first direction and the second direction respectively, Nx and Ny are a modulo parameter of the length in the first direction and a modulo parameter of the length in the second direction respectively, and FLOOR ( ) represents rounding down.

Here, other parameters may also be used as the parameters Nx and/or Ny in expression (3), such that a unique Zone_id can be generated based on x1 and y1.

The position of the UE and the position of the zone reference point may be latitude and longitude coordinates. The first direction and the second direction may be a longitude line direction and a latitude line direction respectively.

The examples of the disclosure further provide an apparatus for transmitting information, performed by UE. As shown in FIG. 8c, the apparatus 200 for transmitting information includes:
a reception module 210c configured to receive reselection time information. The reselection time information is at least configured to determine a cell reselection moment. The reselection time information includes third auxiliary information indicating a cell reselection moment of a reference position in the NTN serving cell.

The example shown in FIG. 8c may be implemented alone or in combination with the examples shown in FIG. 8a and/or FIG. 8b.

Here, the NTN device may send the cell reselection moment of the reference position in the NTN serving cell to the UE. The UE may determine the cell reselection moment based on a distance between the position of the UE and the reference position.

Illustratively, the reference position is the central position of the cell. The closer the UE is to the central position of the cell, the longer the time for which the NTN serving cell can provide service is, and the later the cell reselection moment of the UE is. The farther the UE is from the central position of the cell, the shorter the time for which the NTN serving cell can provide service is, and the earlier the cell reselection moment of the UE is.

The cell reselection moment indicated by the third auxiliary information may be a UTC moment or an ephemeris reference moment.

In an example, after determining the cell reselection moment, the UE may perform measurement on a neighbor cell from the cell reselection moment, and select a neighbor cell satisfying a reselection condition for access.

In this way, the cell reselection moment is determined by means of the reselection time information, and the cell reselection moment is not determined based on a signal measurement result of a serving cell, such that the situation that NTN serving cell coverage cannot cover the UE due to movement of the NTN serving cell is reduced, and a success rate of cell reselection is improved.

In an example, the third auxiliary information indicates:
position information of the reference position;
cell reselection moment information of the reference position; and
coverage of the NTN serving cell.

The NTN device may send the coverage information of the NTN serving cell, the position information of the reference position, and the cell reselection moment corresponding to the reference position to the UE. The UE determines the cell reselection moment of the UE based on a distance between the UE and the reference position.

In an example, the apparatus 200 further includes:
a third determination module 250 configured to determine the cell reselection moment of the UE according to the third auxiliary information, ephemeris information associated with the NTN serving cell, and a position of the UE.

In an example, the UE determines a duration for which the NTN serving cell can provide service according to the position information of the UE, the position information of the reference position, the coverage of the NTN serving cell, movement information of a satellite, etc., and further determines the cell reselection moment of the UE based on first auxiliary information of the cell corresponding to the reference position. The movement information of a satellite may be determined based on ephemeris information of the satellite.

In an example, the reference position includes a central position of the NTN serving cell.

Here, the central position of the NTN serving cell may be determined as the reference position, that is, the central position of a zone covered by the NTN serving cell is a reference. Calculating the coverage of the NTN serving cell based on the central position of the NTN serving cell, etc., may be more convenient, so as to improve efficiency in determining the cell reselection moment of the UE.

In an example, the reception module 210c is configured to perform at least one of the following:
receiving a system message carrying the second auxiliary information;
receiving a system message carrying the third auxiliary information;
receiving RRC signaling carrying the second auxiliary information; or
receiving RRC signaling carrying the third auxiliary information.

Here, the system message may include, but is not limited to, an MIB message, a SIB message, etc. In an example, a first sending module 110a, a first sending module 110b, a first sending module 110c, a reception module 210a, a first determination module 220, a second sending module 230, a reception module 210b, a second determination module 240, a reception module 210c, a third determination module 250, etc. may be implemented by one or more central processing units (CPUs), graphics processing units (GPUs), baseband processors (BPs), application specific integrated circuits (ASICs), digital signal processors (DSPs), programmable logic devices (PLDs), complex programmable logic devices (CPLDs), field-programmable gate arrays (FPGAs), general-purpose processors, controllers, micro controller units (MCUs), microprocessors, or other electronic components, so as to execute the foregoing method.

FIG. 9 is a block diagram of an apparatus 3000 for transmitting information according to an example. For example, the apparatus 3000 may be a mobile phone, a computer, a digital broadcast terminal, a messaging apparatus, a gaming console, a tablet apparatus, a medical apparatus, a fitness apparatus, a personal digital assistant, etc.

With reference to FIG. 9, the apparatus 3000 may include one or more of a processing component 3002, a memory 3004, a power supply component 3006, a multimedia component 3008, an audio component 3010, an input/output (I/O) interface 3012, a sensor component 3014, and a communication component 3016.

The processing component 3002 generally controls overall operation of the device 3000, for example, operation associated with display, phone calls, data communications, camera operations, and recording operations. The processing component 3002 may include one or more processors 3020 to execute an instruction to complete all or some of the steps of the method above. Moreover, the processing component 3002 may include one or more modules to facilitate interaction between the processing component 3002 and other components. For example, the processing component 3002 may include the multimedia module to facilitate interaction between the multimedia component 3008 and the processing component 3002.

The memory 3004 is configured to store various types of data to support an operation on the apparatus 3000. Instances of such data include an instruction, operated on the apparatus 3000, for any application or method, contact data, phonebook data, messages, pictures, video, etc. The memory 3004 may be implemented by any types of volatile or non-volatile memory devices, or their combinations, for example, a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power supply component 3006 supplies power to the various components of the apparatus 3000. The power supply component 3006 may include a power management system, one or more power supplies, and other components associated with power generation, management, and distribution for the apparatus 3000.

The multimedia component 3008 includes a screen that provides an output interface between the apparatus 3000 and the user. In some examples, the screen may include a liquid crystal display (LCD) and a touch panel (TP). If the screen includes a touch panel, the screen may be implemented as a touch screen, so as to receive an input signal from a user. The touch panel includes one or more touch sensors to sense touches, slides, and gestures on the touch panel. The touch sensor may not only sense a boundary of a touch or swipe action, but also detect duration and pressure related to the touch or swipe operation. In some examples, the multimedia component 3008 includes a front-facing camera and/or a rear-facing camera. When the apparatus 3000 is in an operational mode, for example, a photographing mode or a video mode, the front-facing camera and/or the rear-facing camera may receive external multimedia data. Each of the front-facing camera and the rear-facing camera may be a fixed optical lens system or have a focal length and optical zoom capability.

The audio component 3010 is configured to output and/or input audio signals. For example, the audio component 3010 includes a microphone (MIC) configured to receive an external audio signal when the apparatus 3000 is in the operational mode, for example, a calling mode, a recording mode, and a speech identification mode. The received audio signal may be further stored in the memory 3004 or transmitted via the communication component 3016. In some examples, the audio component 3010 further includes a speaker for outputting the audio signal.

The I/O interface 3012 provides an interface between the processing component 3002 and a peripheral interface module. The peripheral interface module may be a keyboard, a click wheel, a button, etc. These buttons may include, but are not limited to, a home button, a volume button, a start button, and a lock button.

The sensor component 3014 includes one or more sensors for providing state assessments of various aspects for the apparatus 3000. For example, the sensor component 3014 may detect an on/off state of the apparatus 3000 and relative positioning of the components. For example, the components are a display and a keypad of the apparatus 3000. The sensor component 3014 may also detect a change in position of the apparatus 3000 or a component of the apparatus 3000, the presence or absence of contact between the user and the apparatus 3000, orientation or acceleration/deceleration of the apparatus 3000, and temperature variation of the apparatus 3000. The sensor component 3014 may include a proximity sensor configured to detect the presence of a nearby object in the absence of any physical contact. The sensor component 3014 may also include a light sensor, for example, a complementary metal oxide semiconductor (CMOS) or charge coupled device (CCD) image sensor, for use in imaging applications. In some examples, the sensor component 3014 may also include an acceleration sensor, a gyroscopic sensor, a magnetic sensor, a pressure sensor, or a temperature sensor.

The communication component 3016 is configured to facilitate communication between the apparatus 3000 and other device in a wired or wireless mode. The apparatus 3000 may access a wireless network based on a communication standard, for example, Wi-Fi, 2G, or 3G, or their combinations. In an example, the communication component 3016 receives a broadcast signal or broadcast related information from an external broadcast management system by means of a broadcast channel. In an example, the communication component 3016 also includes a near field communication (NFC) module to facilitate short-range communication. For example, the NFC module may be implemented based on a radio frequency identification (RFID) technology, an infrared data association (IrDA) technology, an ultra wide band (UWB) technology, a Bluetooth (BT) technology, or other technologies.

In an example, the apparatus 3000 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic elements for executing the method above.

In an example, further provided is a non-transitory computer-readable storage medium including an instruction, for example, a memory 3004 including an instruction, and the instruction may be executed by the processor 3020 of the apparatus 3000 so as to execute the method above. For example, the non-transitory computer-readable storage medium may be a read-only memory (ROM), a random access memory (RAM), a compact disc read-only memory (CD-ROM), a magnetic tape, a floppy disk, an optical data storage apparatus, etc.

Other implementation solutions of the examples of the disclosure will readily occur to those skilled in the art upon consideration of the specification and practical disclosure. The present application is intended to cover any variations, uses, or adaptations of the examples of the disclosure, and these variations, uses, or adaptations follow general principles of the examples of the disclosure and include common general knowledge or customary technical means in the technical field not disclosed in the examples of the disclosure. The specification and examples are considered as illustrative merely, and a true scope and spirit of the examples of the disclosure are indicated by the following claims.

It should be understood that the examples of the disclosure are not limited to the precise structure that has been described above and shown in the accompanying drawings, and that various modifications and changes may be made without departing from the scope of the examples of the disclosure. The scope of the examples of the disclosure is limited merely by the appended claims.

1. A method for transmitting information, executed by a non-terrestrial network (NTN) device, and comprising:
sending reselection time information to user equipment (UE), wherein the reselection time information is at least configured to determine a cell reselection moment, and the reselection time information comprises at least one of the following:
first auxiliary information indicating the cell reselection moment;
second auxiliary information indicating a correspondence relation between each zone in an NTN serving cell and the cell reselection moment; or
third auxiliary information indicating a cell reselection moment of a reference position in the NTN serving cell.

2. The method according to claim 1, wherein the first auxiliary information is determined by the NTN device according to at least the following information:
position information of the UE;
an obtainment time of the position information; and
time information of the UE entering a disconnected state, wherein the disconnected state comprises an idle state or an inactive state.

3. The method according to claim 2, wherein the position information of the UE comprises one of the following:
position information reported when the UE is in a random access process; or
position information reported when the UE is in a radio resource control (RRC) connected state.

4. The method according to claim 1, wherein the sending reselection time information to user equipment (UE) comprises at least one of the following:
sending radio resource control (RRC) release signaling carrying the first auxiliary information to the UE;
sending a system message carrying the second auxiliary information to the UE;
sending a system message carrying the third auxiliary information to the UE;
sending RRC signaling carrying the second auxiliary information to the UE; or
sending RRC signaling carrying the third auxiliary information to the UE.

5. The method according to claim 1, wherein the second auxiliary information comprises:
a zone identifier of each zone, and a cell reselection moment corresponding to each zone identifier.

6. The method according to claim 5, wherein
the second auxiliary information further comprises length information of a length of a zone in a first direction, length information of a length of the zone in a second direction, a modulo parameter of the length in the first direction, a modulo parameter of the length in the second direction, and position information of a zone reference point;
or,
the second auxiliary information further comprises length information of a length of the zone in a first direction, length information of a length of the zone in a second direction, a modulo parameter of the length in the first direction, and a modulo parameter of the length in the second direction.

7. The method according to claim 1, wherein
the third auxiliary information comprises:
position information of the reference position;
cell reselection moment information of the reference position; and
coverage information of the NTN serving cell.

8. (canceled)

9. (canceled)

10. A method for transmitting information, executed by user equipment (UE), and comprising:
receiving reselection time information, wherein the reselection time information is at least configured to determine a cell reselection moment, and the reselection time information comprises at least one of the following:
first auxiliary information indicating the cell reselection moment;
second auxiliary information comprising a correspondence relation between each zone in an NTN serving cell and the cell reselection moment; or
third auxiliary information indicating a cell reselection moment of a reference position in the NTN serving cell.

11. The method according to claim 10, further comprising:
determining the cell reselection moment of the UE according to the first auxiliary information.

12. The method according to claim 11, further comprising:
reporting position information of the UE and an obtainment time of the position information.

13. The method according to claim 12, wherein the position information of the UE comprises one of the following:
position information reported when the UE is in a random access process; or
position information reported when the UE is in an RRC connected state.

14. The method according to claim 10, wherein the receiving reselection time information comprises at least one of the following:
receiving radio resource control (RRC) release signaling carrying the first auxiliary information;
receiving a system message carrying the second auxiliary information;
receiving a system message carrying the third auxiliary information;
receiving RRC signaling carrying the second auxiliary information; or
receiving RRC signaling carrying the third auxiliary information.

15. The method according to claim 10, wherein the second auxiliary information comprises:
a zone identifier of each zone, and a cell reselection moment corresponding to each zone identifier.

16. The method according to claim 15, wherein
the second auxiliary information further comprises length information of a length of a zone in a first direction, length information of a length of the zone in a second direction, a modulo parameter of the length in the first direction, a modulo parameter of the length in the second direction, and position information of a zone reference point;
or,
the second auxiliary information further comprises length information of a length of the zone in a first direction, length information of a length of the zone in a second direction, a modulo parameter of the length in the first direction, and a modulo parameter of the length in the second direction.

17. The method according to claim 16, further comprising:
determining the cell reselection moment of the UE according to the second auxiliary information.

18. The method according to claim 17, wherein the determining the cell reselection moment of the UE according to the second auxiliary information comprises:
determining a corresponding first distance between the UE and the zone reference point in the first direction, and a corresponding second distance between the UE and the zone reference point in the second direction;
rounding a quotient obtained by dividing the first distance by the length of the zone in the first direction, obtaining a first integer quotient, performing modulo operation on the first integer quotient by using the modulo parameter of the length in the first direction, and obtaining a first modulo value;
rounding a quotient obtained by dividing the second distance by the length of the zone in the second direction, obtaining a second integer quotient, performing modulo operation on the second integer quotient by using the modulo parameter of the length in the second direction, and obtaining a second modulo value;
determining a zone identifier of a zone where the UE is located based on the first modulo value and the second modulo value; and
determining the cell reselection moment corresponding to the zone identifier of the zone where the UE is located.

19. (canceled)

20. The method according to claim 10, wherein
the third auxiliary information indicates:
position information of the reference position;
cell reselection moment information of the reference position; and
coverage of the NTN serving cell.

21. The method according to claim 20, further comprising:
determining the cell reselection moment of the UE according to the third auxiliary information, ephemeris information associated with the NTN serving cell, and a position of the UE.

22-44. (canceled)

45. A communication device, comprising a processor, a memory, and an executable program stored in the memory and executable by the processor, wherein the processor executes steps of the method for transmitting information according to claim 1 when running the executable program.

46. A communication device, comprising a processor, a memory, and an executable program stored in the memory and executable by the processor, when the executable program is executed by the processor, cause the processor to execute:
receive reselection time information, wherein the reselection time information is at least configured to determine a cell reselection moment, and the reselection time information comprises at least one of the following:
first auxiliary information indicating the cell reselection moment;
second auxiliary information comprising a correspondence relation between each zone in an NTN serving cell and the cell reselection moment; or
third auxiliary information indicating a cell reselection moment of a reference position in the NTN serving cell.
